(19) United States
(12) Patent Application Publication
(10) Pub. No.: US 2024/0388954 A1
(43) Pub. Date: Nov. 21, 2024

(54) AI-DRIVEN WIRELESS RADIO RESOURCE MANAGEMENT FOR OPTIMIZATION OF USER EXPERIENCE

(71) Applicant: Cisco Technology, Inc., San Jose, CA (US)

(72) Inventors: Michal Wladyslaw Garcarz, Krakow (PL); Jean-Philippe VASSEUR, Combloux (FR); Grégory MERMOUD, Venthône (CH); Eduard SCHORNIG, Haarlem (NL); Pierre-André SAVALLE, Rueil-Malmaison (FR)

(21) Appl. No.: 18/197,458

(22) Filed: May 15, 2023

(51) Int. Cl. H04W 28/02; H04B 7/0426

(52) U.S. Cl. CPC H04W 28/0263; H04B 7/043; H04W 28/0221; H04W 28/0236

(57) ABSTRACT

In one embodiment, a device obtains telemetry data associated with a particular online application accessed via a wireless network. The device computes statistics regarding traffic associated with the particular online application in the wireless network. The device generates a wireless configuration for an access point of the wireless network based on the telemetry data and the statistics. The device provides the wireless configuration for use by the access point when communicating with a client of the particular online application.

### TECHNICAL FIELD

The present disclosure relates generally to computer networks, and, more particularly, artificial intelligence (AI)-driven wireless radio resource management for optimization of user experience.

### BACKGROUND

Many wireless networks now rely on Radio Resource Management (RRM) that centrally control the operations of the infrastructure of the network in an effort to optimize the network. For instance, RRM often seeks to control parameters such as the wireless channels in use, the transmit power levels, the channel widths (which affect bandwidth), and the like, to help ensure that the wireless network provides the best coverage possible to the various clients of the network. To do so, RRM bases these decisions on measurements such as the Received Signal Strength Indicator (RSSI), signal-to-noise (SNR) metrics, etc. collected from the wireless network.

One observation herein, though, is that RRM is entirely agnostic as to the effects of its decisions on the quality of experience (QoE) of the applications with which the clients of the wireless network communicate. Application QoE is also largely subjective and highly dependent on the application itself, meaning that optimizing the network with a specific configuration for any given client may not be optimal from the standpoint of the application(s) that the client uses. For instance, RRM today would typically increase the transmit power for communications with a client having low RSSI, but the nature of the application used by that client may be such that its QoE is already satisfactory, meaning that the increase was unnecessary and a waste of resources.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example wireless network;

FIG. 5 illustrates an example architecture for artificial intelligence (AI)-driven wireless radio resource management for optimization of user experience; and

FIG. 6 illustrates an example simplified procedure for AI-driven wireless radio resource management for optimization of user experience.

### DESCRIPTION OF EXAMPLE EMBODIMENTS

### Overview

According to one or more embodiments of the disclosure, a device obtains telemetry data associated with a particular online application accessed via a wireless network. The device computes statistics regarding traffic associated with the particular online application in the wireless network. The device generates a wireless configuration for an access point of the wireless network based on the telemetry data and the statistics. The device provides the wireless configuration for use by the access point when communicating with a client of the particular online application.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

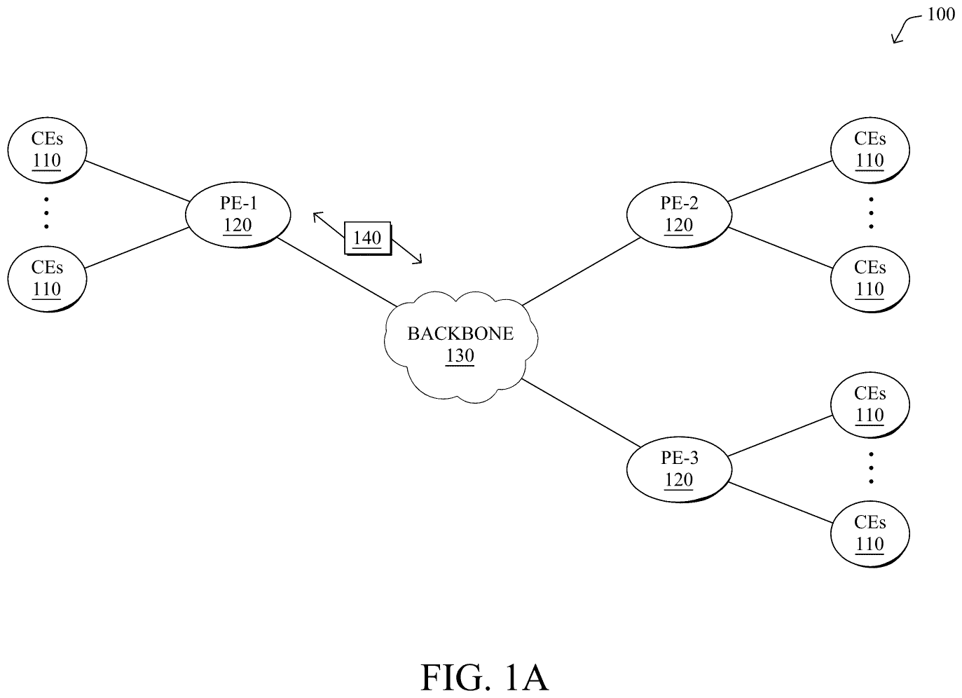

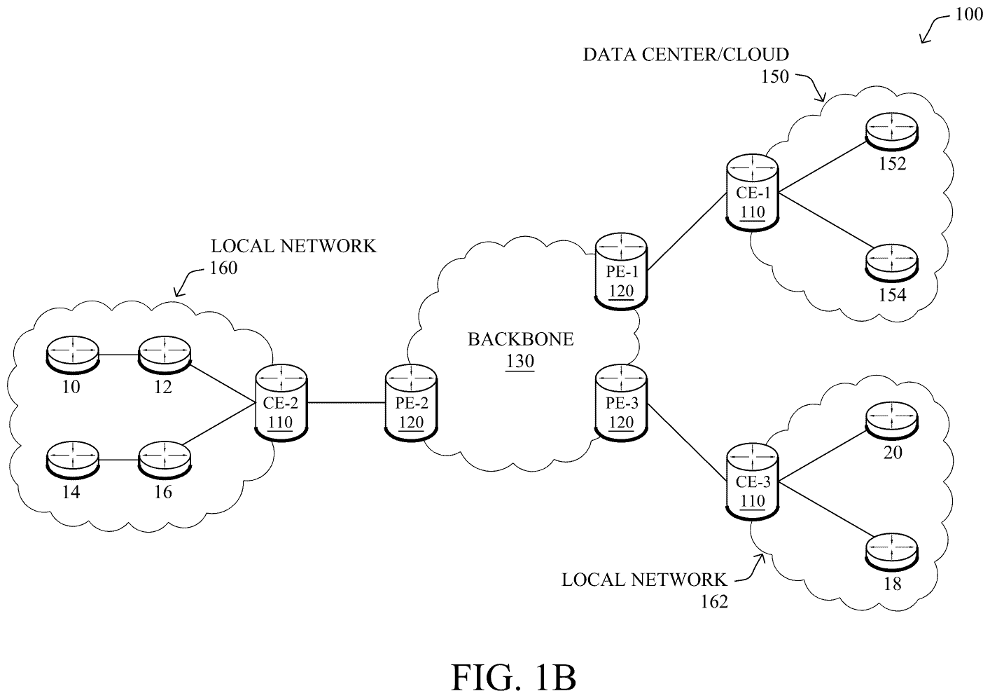

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

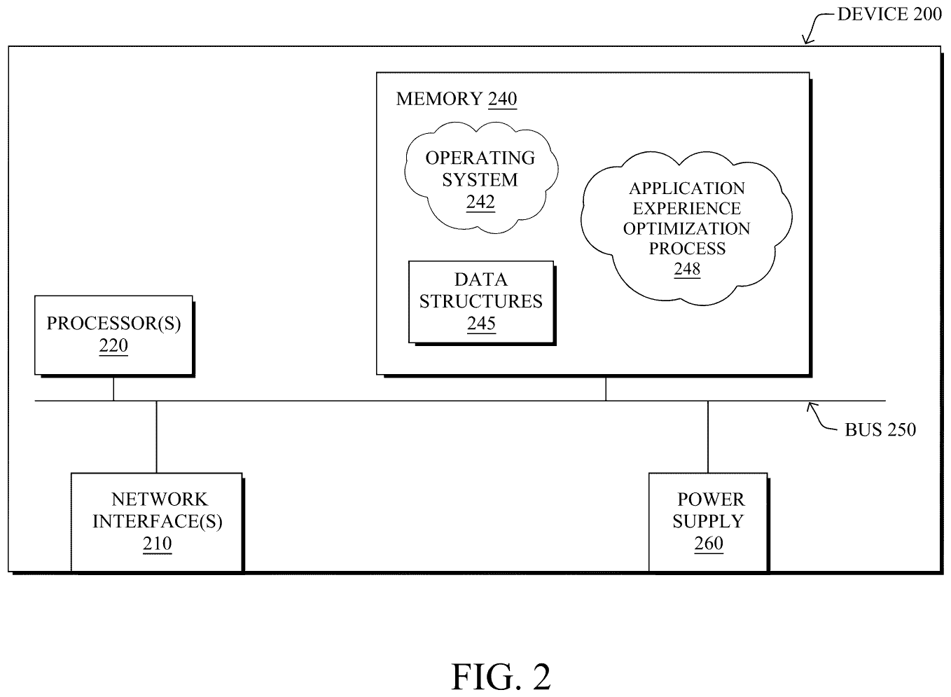

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as Internet of Things (IoT) nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, application experience optimization process 248 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

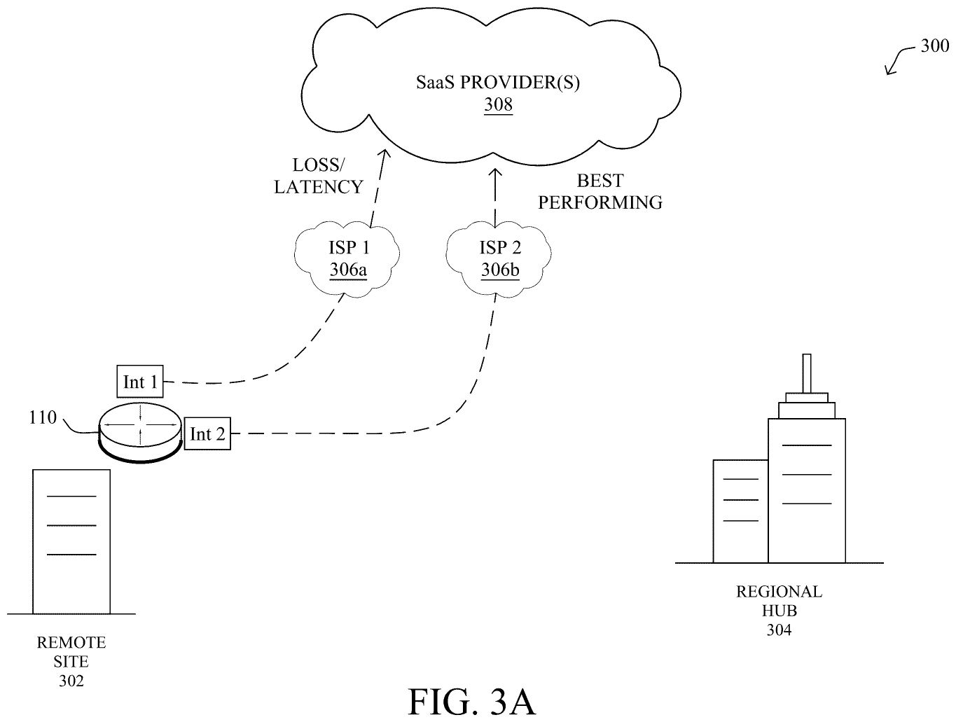

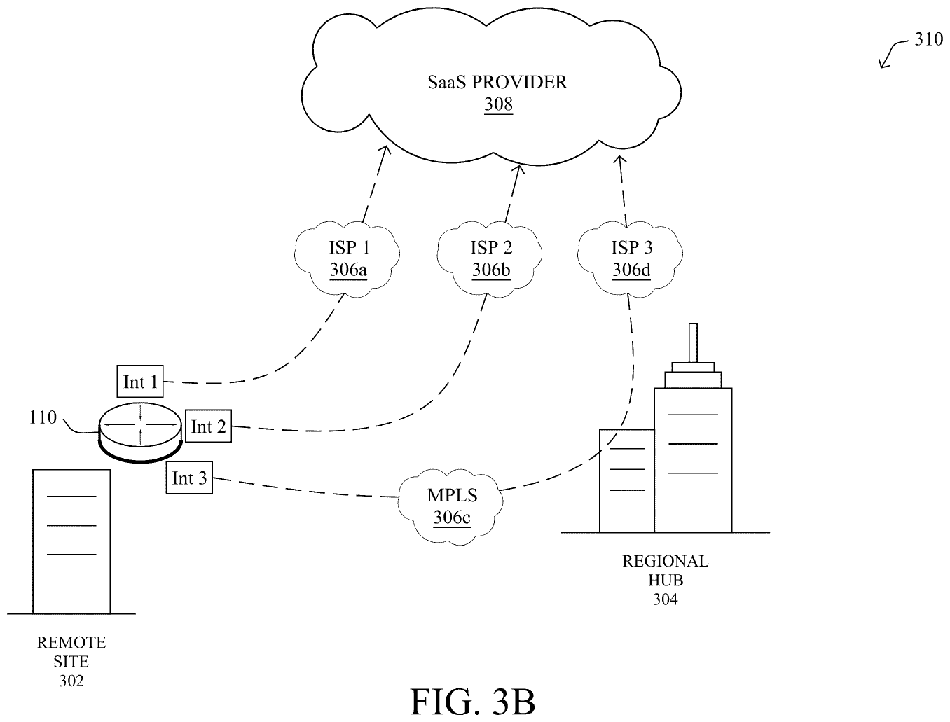

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

As noted above, wireless communication using the IEEE 802.11 set of standards is key for modern communication both on consumer and enterprise markets. In recent years, many wireless networks rely on using Radio Resource Management (RRM) functionality, with the goal of providing the best possible wireless quality at any point in time. To achieve that, the following set of services have been developed and are commonly used:
Flexible Radio Assignment (FRA): tracking AP's radio interface (2.4 Ghz, 5 Ghz, 6 Ghz) redundancy and proposing new modes for redundant interfaces.
Dynamic Channel Assignment (DCA): dynamically adjusting the channel number (frequency) per radio interface to avoid co-channel interference.
Transmit Power Control (TCP): adjusting power per radio interface to avoid interference and maximize coverage.
Dynamic Bandwidth Selection (DBS): dynamically adjusting channel width (20/40/80/160 MHz) per radio interface to avoid interference and maximize bandwidth.

The above services are closely related to each other and use different Layer-2 metrics, such as signal-to-noise-ratio (SNR), received signal strength indicator (RSSI), SNR, RSSI, overlapped basic service set (OBSS) ratio, and the like, to generate and enforce the “optimal” radio configuration for the whole wireless network, with the goal to:
Minimize the number of wireless clients with poor connectivity (the most common dominating KPI).
Have acceptable wireless coverage in desired locations
Be capable of supporting the expected number of wireless clients. Conversely, some of the reasons for poor client connectivity are:
Lack of range/wireless coverage—e.g., the access point (AP) is too far away, or the transmitting power is not high enough.
High co-channel interference caused by neighboring AP and/or another client.
Saturation of the AP's radio/wired interfaces.

Another improvement for 802.11 communication consists in beamforming technologies, such ClientLink by Cisco Systems, Inc. This solution uses dedicated hardware capabilities to focus a wireless signal toward specific clients. Such solutions aim to improve wireless quality but are always limited by the underlying hardware (e.g., number of beams supported at the same time) and overall radio environment (e.g., interferences).

Yet another significant stage in the evolution of RRM-based systems was the adoption of machine learning-based methods to analyze huge amount telemetry in real-time and generate required changes automatically. Such systems operate in the cloud (because of scale/amount of gathered telemetry) and can provide recommendations by leveraging historical data, baselines, comparison to other customers/profiles and simulations run on that historical data. An example of such a solution is the Cisco AI RRM solution.

Despite these advances, existing RRM-based systems do not take into account users and applications and they exclusively optimize the Wi-Fi network for Layer 1 (L1)/Layer 2 (L2) networking key performance indicators (KPIs), thus potentially not optimizing the network for the proper metric (i.e., L1-L2, as opposed to Layer 7 thanks to QoE metrics)). Thus, two questions are completely ignored by RRM approaches today:
What kind of applications are used by specific wireless users?
What is the volume of that traffic and per application requirement in terms of network to get acceptable application user experience?

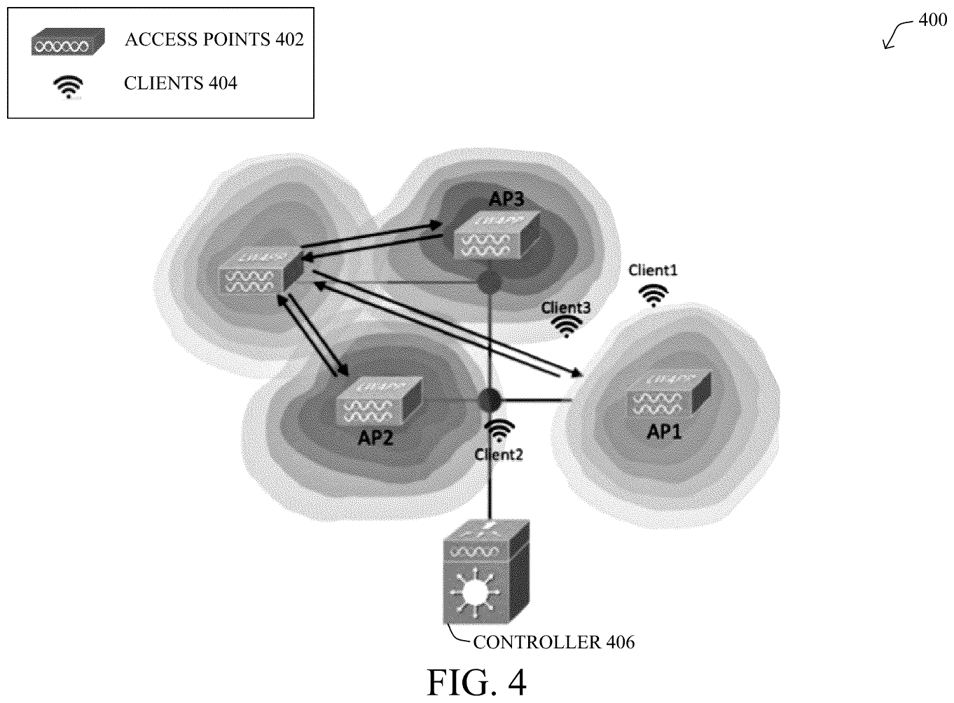

While most wireless solutions allow for the collection of telemetry such as active users, traffic volumes, and application usage, this data is not used when running RRM and optimizing radio parameters. By way of example, consider the wireless network 400 shown in FIG. 4. As shown, wireless network 400 may include any number of access points 402, such as AP 1, AP 2, AP 3, and AP 4, each of which is controlled by a controller 406. In addition, there may be any number of clients 404, such as Client1, Client2, and Client3 shown, which rely on access points 402 for wireless connectivity.

Here, traditional RRM adjusting the wireless radios of access points 402 to achieve the same coverage/quality for all clients 404 actually might not make sense. This is because each wireless client is unique, might use different applications, and might have quite different network requirements depending on the applications being used.

For example, Client1 might be an IoT sensor reporting a measured humidity level. That client might have low RSSI, but still enough of a signal to send periodic humidity level updates. As a result, there is no need for RRM to increase AP power to get better RSSI for that client and such an action may also increase interferences with AP2 and AP3, which would additionally have to be compensated.

The same is true for all beamforming streams: it does not make sense to use this technology for all clients (which is not possible because of hardware limitation), instead it would be wise to rationalize the usage of beamforming only to devices that really need it to improve their application Quality of Experience (QoE).

A similar logic can be applied to roaming services (802.11k and 802.11v) where the decision to roam (move) the client to another AP is based purely on L1/L2 metrics without considering real application usage and experience score.

### AI-Driven Wireless RRM for Optimization of User Experience

The techniques herein introduce an RRM mechanism that makes use of application-level telemetry and inferred QoE scores (e.g., by using specially trained machine learning QoE models) to optimize the radio configurations in a wireless network, with the end goal of increasing end user satisfaction in the wireless network. In some aspects, such a cross-layer approach consisting in tuning the Wi-Fi configuration while optimizing the application experience.

Illustratively, the techniques described herein may be performed by hardware, software, and/or firmware, such as in application experience optimization process 248, which may include computer executable instructions executed by the processor 220 (or independent processor of interfaces 210) to perform functions relating to the techniques described herein.

Specifically, according to various embodiments, a device obtains telemetry data associated with a particular online application accessed via a wireless network. The device computes statistics regarding traffic associated with the particular online application in the wireless network. The device generates a wireless configuration for an access point of the wireless network based on the telemetry data and the statistics. The device provides the wireless configuration for use by the access point when communicating with a client of the particular online application.

Operationally, the goals of the application-driven RRM introduced herein include:
Generating FRA, DCA, TPC, and/or DBS radio recommendations based on client application usage and (if possible) on experience score per application.
Optimizing the use of beamforming based on application traffic and experience score, and avoid scenarios where it might not significantly improve QoE (as to save precious hardware resources).
Generating roaming events/recommendations designed to significantly improve user experience and generating the opposite events when it would not. For example: “during a Cisco WebEx call from Mobile agent, please switch to another AP/roam (based on direct L7 feedback from WebEx).” In another example: “please avoid switching AP, because it will not improve your O365 performance which is the dominating application right now.”
Long term recommendations from RRM based on historical application usage and experience (e.g., change AP location, buy new AP, buy new AP in 3 weeks from now, because based on current trends it will not be possible to accommodate current client growth without substantial app QoE degradation).
Provide simulation capabilities that allow a network administrator to assess RRM settings based on application driven input and output. For example, to answer the question “what would be the RRM proposal if most of my users migrate from Zoom to Cisco WebEx?” In another example, to answer the question “what will my RRM proposal be if there will be additional 100 O365 users in my location (on average).” In yet another example, to answer the question “how should I redesign my wireless network to increase average application QoE from 8 to 9, my budget is $10,000 USD.”

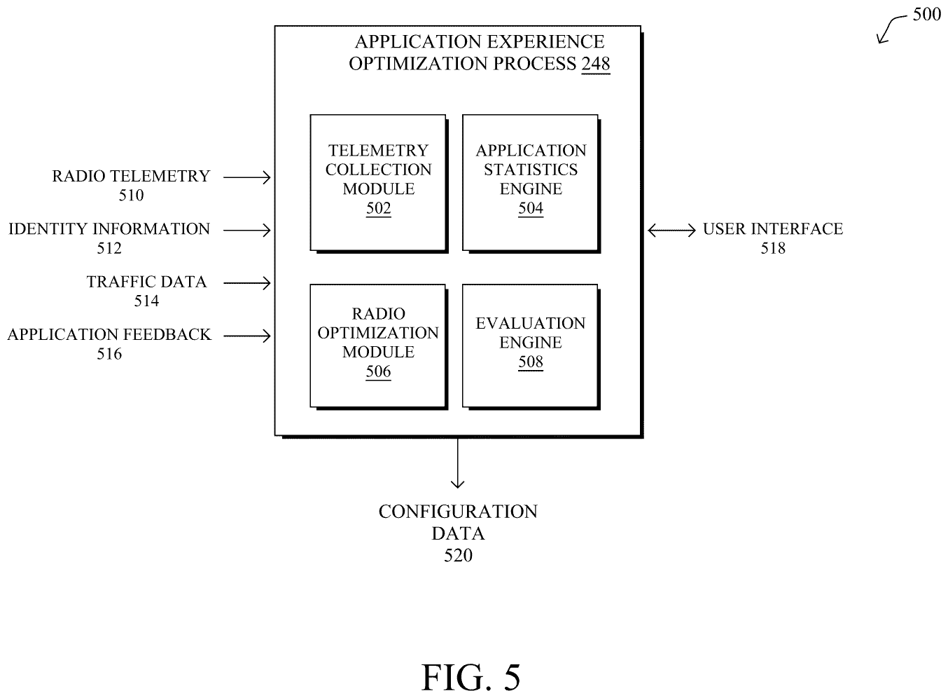

Operationally, FIG. 5 illustrates an example architecture for artificial intelligence (AI)-driven wireless radio resource management for optimization of user experience, according to various embodiments. At the core of architecture 500 is application experience optimization process 248, which may be executed by a controller for a network, a networking device, or another device in communication therewith. For instance, application experience optimization process 248 may be executed by a controller for a network (e.g., a wireless controller), another device or service in communication therewith, or any other device in a network.

As shown, application experience optimization process 248 may include any or all of the following components: telemetry collection module 502, application statistics engine 504, radio optimization module 506, and/or evaluation engine 508. As would be appreciated, the functionalities of these components may be combined or omitted, as desired (e.g., implemented as part of application experience optimization process 248). In addition, these components may be implemented on a singular device or in a distributed manner, in which case the combination of executing devices can be viewed as their own singular device for purposes of executing application experience optimization process 248.

In various embodiments, telemetry collection module 502 may responsible for gathering various telemetry, either on a pull or push basis, such as any or all of the following:
Radio telemetry 510—e.g., all types of radio related telemetry gathered by existing RRM systems, from wireless controllers, from clients, and/or APs.
Identity information 512—information about client types and roles gathered by integration with identity systems. For example, a Cisco Wireless LAN Controller (WLC) may report that an endpoint is an Apple IOS 13 mobile device or a wireless HP107w printer. In such a case, telemetry collection module 502 may retrieve this information from Cisco Identity Services Engine (profiling services) or Mobile Device Management solutions like Mobile Iron. Here, if the endpoint is classified as an IoT sensor role, its networking requirements might be minimal.
Traffic data 514—generally, this may include any information about the traffic from each wireless client, including the applications in use. For instance, telemetry collection module 502 may fetch this data directly from the client using agents running on the client (e.g., Cisco AnyConnect with a Network-Based Application Recognition (NBAR) application recognition engine, or Thousand Eyes Endpoint agent being able to discover web-based application). Alternatively, telemetry collection module 502 may obtain this information from the underlying network devices, such as from IOS-XE routers hosting wireless LAN controllers and running NBAR engine to detect applications (or IOS-XE within the SDWAN fabric). Another method to retrieve the same statistical information is to use 802.11 extensions, like Cisco Compatible Extensions (CCX), to allow endpoints to send such telemetry to access points. A possible implementation could use beacon frames along with something like traffic indication map (TIM) in order to encode and encrypt relevant information.
Application feedback 516—There are multiple possible sources of user experience score per application. Those include automated systems where a machine learning model is configured to compute a user experience score based on raw telemetry (solutions like Thousand Eyes Endpoint user experience score or Cisco WebEx User experience score or Microsoft Informed Routing integrated with Cisco Viptela SDWAN). In other embodiments, though, the experience score values may be based on real human feedback (Cisco Cognitive Networks, AWS Mechanical Turk, etc.). Those experience scores will be attached (whenever available/possible) to the telemetry statistics gathered above.

In turn, telemetry collection module 502 may then combine any or all of the above (and potentially statistics derived therefrom, as well), into a single dataset. For instance, such a dataset may look similar to Table 1 below:

TABLE 1

| Client | | | | |
|---|---|---|---|---|
| ID (with | | Timestamp | | |
| MAC or | | (5 min | | User feedback |
| UUID) | Client type/role | range) | Application statistics | and source |
| 1 | MacBook Pro 16 | 2023-03-04 | 0365: SharePoint | 6/10: TE |
| | BigSur | 11:30-11:35 | (bytes/packets + | experience |
| | | | HAR/waterfall) | score |
| 1 | MacBook Pro 16 | 2023-03-04 | 0365: SharePoint | 7/10: mTurk |
| | BigSur | 11:30-11:35 | (bytes/packets + | score |
| | | | HAR/waterfall) | |
| 1 | MacBook Pro 16 | 2023-03-04 | 0365: SharePoint | 5/10: MSFT |
| | BigSur | 11:30-11:35 | (bytes/packets + | Informed |
| | | | HAR/waterfall) | routing score |
| 1 | MacBook Pro 16 | 2023-03-04 | WebEx (meetings | 9/10: CogNet |
| | BigSur | 11:30-11:35 | details, codec details, | Bot |
| | | | audio/video | |
| | | | frequency/resolution, | |
| | | | etc.) | |
| 1 | MacBook Pro 16 | 2023-03-04 | WebEx (meetings | 8/10: WebEx |
| | BigSur | 11:30-11:35 | details, codec details, | Experience |
| | | | audio/video | score |
| | | | frequency/resolution, | |
| | | | etc.) | |
| 1 | MacBook Pro 16 | 2023-03-04 | ServiceNow | — |
| | BigSur | 11:30-11:35 | (bytes/packets + | |
| | | | HAR/waterfall) | |

The above example shows a single computer connected to a WebEx meeting and using SharePoint and ServiceNow during a specific time interval. Telemetry collection module 502 may gather all radio attributes along with application statistics relating to that computer. Also, if possible, telemetry collection module 502 may also obtain and associate the application QoE metrics, as well (obtained from different sources).

In various embodiments, application statistics engine 504 may processes the telemetry gathered by telemetry collection module 502 and extract attributes and features which will be used by an RRM mechanism when making radio optimization decisions. For instance, one such feature may indicate whether the application is actively being used by the endpoint. For instance, if a SharePoint browser tab is open (generating network traffic), but the user is not actively working on it, then it does not make sense to optimize wireless network for the SharePoint application for that user.

Yet another attribute that application statistics engine 504 may identify is the statistical pattern of network traffic from each client. If, statistically and for a certain hour of the day, the network overhead for the WebEx application is typically high, then the system should optimize the wireless network around that time for high WebEx throughput.

Another potential attribute could be indicative of whether the application traffic was generated by a human user or automatically generated by the endpoint device.

In some embodiments, application statistics engine 504 may also normalize the telemetry from telemetry collection module 502. For example, RRSI ranges used by Cisco are in a range of 0-100, while Atheros uses a range of 0-60. In such a case, application statistics engine 504 may normalize the RSSI values to a common range. The same is true for different application recognition engines (NBAR running on a router vs. NBAR running on an endpoint might discover the same applications under different name), which application statistics engine 504 could also normalized. In addition, application statistics engine 504 may also need to normalize experience score metrics obtained from different sources. For instance, Microsoft Informed Routing scores only have four possible values: bad, good, unknown, and neutral, while Cisco Predictive Networks scores range from 1 to 100, or from 1 to 10.

For example, Table 2 below shows an example output of application statistics engine 504, which enriches the raw telemetry from telemetry collection module 502 with statistical data:

TABLE 2

| Client id | | | | | |
|---|---|---|---|---|---|
| (with | Timestamp | | | Active | |
| MAC or | (range | | Peak hours, | traffic | Machine |
| UUID) | varies) | Application | variance | detection | generated |
| 1 | Last 7 d | 0365: SharePoint | 8-9, 16-17 | 40% of | 20% of that |
| | | long term | UTC. | flows is idle | app traffic |
| | | statistics like | Variance 3 | traffic, 60% | generated |
| | | bytes/packets rat | | active, | by machine |
| | | o, but also HAR | | intensity 8 | |
| | | resource stat | | | |
| | | stics | | | |
| 1 | Last 24 h | 0365: | 8-9, 15-17 | 90% of | 40% of that |
| | | SharePoint long | UTC. | flows is idle | app traffic |
| | | term statistics | Variance 2 | traffic, 10% | generated |
| | | like | | active: | by machine |
| | | bytes/packets | | intensity 5 | |
| | | ratio, but also | | | |
| | | HAR resource | | | |
| | | statistics | | | |

The above table contains statistical data for specific client, which could be treated as a statistical application profile. Here, the last 24 hours might be different for that client then the last 7 days. As detailed below, that statistical data might be important for radio optimization module 506 generating RRM optimization proposals. For example, if the specific endpoint generates idle traffic for a specific application 90% of the time or flows, then it does not make sense to improve its quality (because that application is not used actively by a human being).

In various embodiments, radio optimization module 506 estimates, based on historical data (and possibly across all customers and/or wireless clients), whether changing any of the RRM parameters generated by FRA, DCA, TPC, DBS would potentially improve the application user experience for each user. To do so, radio optimization module 506 may leverage statistical techniques and/or machine learning techniques that take as input the information produced by application statistics engine 504.

For example, assume that the currently observed user experience for WebEx is 7.0 (e.g., on a 0-10 rating scale) with RSSI=30, based on historical data statistical models. In such a case, radio optimization module 506 may suggest that to get WebEx experience score above 8.0, an RSSI of 40 or better is needed. Also, when RSSI=30 for WebEx, it is common to see the video codec resolution to be significantly lower than for higher RSSI values. Based on that, radio optimization module 506 may decide to increase the power of a specific AP to improve the RSSI for the client expecting WebEx score to increase. As would be appreciated, the above example is simplified for illustrative purposes, as there are potentially hundreds of attributes (or even more) which might influence the application experience score. This is why machine learning is particularly well suited to make these types of decisions.

In some embodiments, radio optimization module 506 may also make similar recommendations with respect to beamforming. For instance, if an endpoint client is generating little to no traffic, or more traffic but its application scores are very high, then it does not make sense to use beamforming for that client and radio optimization module 506 may recommend disabling beamforming for that client.

In further embodiments, radio optimization module 506 may also make recommendations regarding client roaming, as roaming between APs can also have an effect on the application experience. To do so, radio optimization module 506 may base these decisions on historical data (e.g., using a model trained on a large amount of such changes observed for all customers/clients along with their impacts on application experience). In addition, an administrator could also configure heuristic rules for use by radio optimization module 506 with respect to its roaming decisions. For example, such a rule may cause radio optimization module 506 to be more aggressive when roaming between APs on the same floor, and less aggressive when roaming between APs on different floors.

In various embodiments, evaluation engine 508 may check whether any change recommended by radio optimization module 506 indeed improved the user experience, with the goals of: 1.) finding the best settings for specific client/network at that point of time and 2.) tuning the machine learning models and algorithms for better discovery of important features that influence the application experience. To do so, evaluation engine 508 may run in a loop and change different sets of radio parameters multiple times, in order to find the most desired one and improve the machine learning models to the state which is desired/acceptable (e.g., using a multi-arm bandit algorithm type of approach).

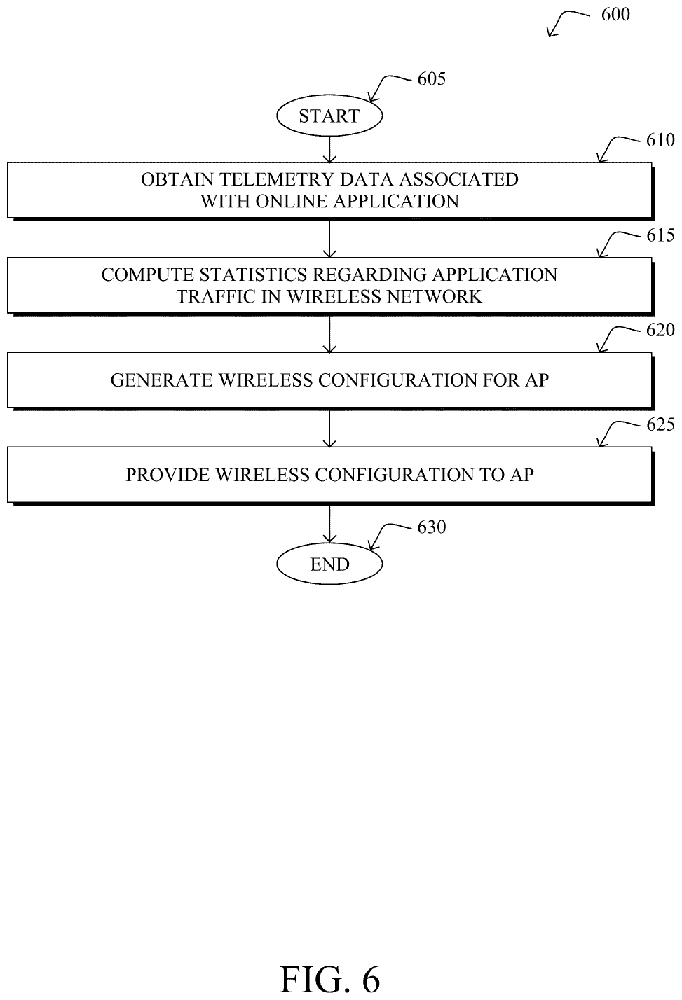

FIG. 6 illustrates an example simplified procedure for AI-driven wireless radio resource management for optimization of user experience, in accordance with one or more embodiments described herein. For example, a non-generic, specifically configured device (e.g., device 200), such as controller for a network (e.g., a wireless network controller, etc.), an edge router, or other device in communication with a network, may perform procedure 600 by executing stored instructions (e.g., application experience optimization process 248). The procedure 600 may start at step 605, and continues to step 610, where, as described in greater detail above, the device may obtain telemetry data associated with a particular online application accessed via a wireless network. In some embodiments, the telemetry data is generated at least in part by the particular online application. In further embodiments, the telemetry data associated with the particular online application is indicative of a device type of the client.

At step 615, as detailed above, the device may compute statistics regarding traffic associated with the particular online application in the wireless network. In some embodiments, statistics are indicative of when traffic associated with the particular online application is sent via the wireless network.

At step 620, the device may generate wireless configuration for an access point of the wireless network based on the telemetry data and the statistics, as described in greater detail above. In one embodiment, the wireless configuration controls whether the access point uses beamforming when communicating with the client. In another embodiment, the wireless configuration controls a transmit power level of the access point when communicating with the client. In yet another embodiment, the wireless configuration controls whether the client is to roam to a different access point. In an additional embodiment, the wireless configuration modifies a radio resource management (RRM) function in the wireless network.

At step 625, as detailed above, the device may provide the wireless configuration for use by the access point when communicating with a client of the particular online application. For instance, the device may provide the wireless configuration directly to the access point, to a controller for the access point, etc. In some embodiments, the device may also determine whether the wireless configuration had an effect on a user experience score associated with the particular online application.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for AI-driven wireless radio resource management for optimization of user experience, it is to be understood that various other adaptations and modifications may be made within the spirit and scope of the embodiments herein. For example, while certain embodiments are described herein with respect to using certain models for purposes of predicting application experience metrics, application QoE, disruptions in a network, etc., the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, telemetry data associated with a particular online application accessed via a wireless network;
computing, by the device, statistics regarding traffic associated with the particular online application in the wireless network;
generating, by the device, a wireless configuration for an access point of the wireless network based on the telemetry data and the statistics; and
providing, by the device, the wireless configuration for use by the access point when communicating with a client of the particular online application.

2. The method as in claim 1, wherein the telemetry data is generated at least in part by the particular online application.

3. The method as in claim 1, wherein the statistics are indicative of when traffic associated with the particular online application is sent via the wireless network.

4. The method as in claim 1, wherein the telemetry data associated with the particular online application is indicative of a device type of the client.

5. The method as in claim 1, wherein the telemetry data associated with the particular online application comprises user experience scores for the particular online application.

6. The method as in claim 1, further comprising:
determining, by the device, whether the wireless configuration had an effect on a user experience score associated with the particular online application.

7. The method as in claim 1, wherein the wireless configuration controls whether the access point uses beamforming when communicating with the client.

8. The method as in claim 1, wherein the wireless configuration controls a transmit power level of the access point when communicating with the client.

9. The method as in claim 1, wherein the wireless configuration controls whether the client is to roam to a different access point.

10. The method as in claim 1, wherein the wireless configuration modifies a radio resource management (RRM) function in the wireless network.

11. An apparatus, comprising:
one or more network interfaces;
a processor coupled to the one or more network interfaces and configured to execute one or more processes; and
a memory configured to store a process that is executable by the processor, the process when executed configured to:
obtain telemetry data associated with a particular online application accessed via a wireless network;
compute statistics regarding traffic associated with the particular online application in the wireless network;
generate wireless configuration for an access point of the wireless network based on the telemetry data and the statistics; and
provide the wireless configuration for use by the access point when communicating with a client of the particular online application.

12. The apparatus as in claim 11, wherein the telemetry data is generated at least in part by the particular online application.

13. The apparatus as in claim 11, wherein the statistics are indicative of when traffic associated with the particular online application is sent via the wireless network.

14. The apparatus as in claim 11, wherein the telemetry data associated with the particular online application is indicative of a device type of the client.

15. The apparatus as in claim 11, wherein the telemetry data associated with the particular online application comprises user experience scores for the particular online application.

16. The apparatus as in claim 11, wherein the process when executed is further configured to:
determine whether the wireless configuration had an effect on a user experience score associated with the particular online application.

17. The apparatus as in claim 11, wherein the wireless configuration controls whether the access point uses beamforming when communicating with the client.

18. The apparatus as in claim 11, wherein the wireless configuration controls a transmit power level of the access point when communicating with the client.

19. The apparatus as in claim 11, wherein the wireless configuration controls whether the client is to roam to a different access point.

20. A tangible, non-transitory, computer-readable medium storing program instructions that cause a device to execute a process comprising:
obtaining, by the device, telemetry data associated with a particular online application accessed via a wireless network;
computing, by the device, statistics regarding traffic associated with the particular online application in the wireless network;
generating, by the device, a wireless configuration for an access point of the wireless network based on the telemetry data and the statistics; and
providing, by the device, the wireless configuration for use by the access point when communicating with a client of the particular online application.
